(19) United States
(12) Patent Application Publication
(10) Pub. No.: US 2026/0158724 A1
(43) Pub. Date: Jun. 11, 2026

(54) PACKAGING FILM AND MANUFACTURING METHOD THEREOF

(71) Applicant: TSANG-YI HSU, Tainan City (TW)

(72) Inventor: TSANG-YI HSU, Tainan City (TW)

(21) Appl. No.: 19/408,431

(22) Filed: Dec. 4, 2025

(30) Foreign Application Priority Data
Dec. 6, 2024 (TW) 113147515

(51) Int. Cl. B29C 48/00; B29B 9/06; B29C 48/08; B29K 23/00; B29K 105/24

(52) U.S. Cl. CPC B29C 48/022; B29C 48/08; B29B 9/06; B29K 2023/08; B29K 2105/24

(57) ABSTRACT

A method includes the following steps: performing a pelletizing process for a polyolefin elastomer, a crosslinking agent, and a silane coupling agent while simultaneously performing a crosslinking and grafting reaction to produce a plurality of material pellets including a first portion in which the crosslinking and grafting reaction has been completed and a second portion in which the crosslinking and grafting reaction has not been completed; mixing the first portion and the second portion to produce a mixed material; feeding the mixed material into the feed inlet of an extruder, and heating and compressing the mixed material by a heater and a threaded rod of the extruder; delivering the heated and compressed mixed material to a hanger-shaped die head through the discharge outlet of the extruder; extruding the mixed material through the hanger-shaped die head to form a packaging film; and leveling the packaging film by a leveling machine.

### CROSS REFERENCE TO RELATED APPLICATION

This application also claims priority to Taiwan Patent Application No. 113147515 filed in the Taiwan Patent Office on Dec. 6, 2024, the entire content of which is incorporated herein by reference.

### TECHNICAL FIELD

The present disclosure relates to a packaging film. The present disclosure further relates to the manufacturing method of the packaging film.

### BACKGROUND

OPV (Organic Photovoltaic) refers to a solar photovoltaic device fabricated by organic materials, which can convert solar energy into electrical energy. OPV is an emerging solar energy technology and offers advantages such as light weight, flexibility, and low manufacturing cost.

During operation, solar cells are susceptible to degradation or even failure due to natural factors, such as heat, light, oxygen, and moisture, which can lead to a reduction in photoelectric conversion efficiency. Accordingly, packaging films are commonly used to protect solar cells and to tightly bond the cells with materials such as glass and back sheets into an integrated structure. Packaging materials play roles such as sealing and protection within photovoltaic modules. As requirements for packaging films continue to increase, packaging films having different performance characteristics have attracted widespread attention.

POE (Polyolefin Elastomer) is a polymer known for its flexibility, strength, and resistance to various environmental factors. POE exhibits characteristics such as low density, elasticity, toughness, and chemical resistance, and is capable of maintaining flexibility over a wide temperature range. Thus, this material is valuable in numerous industrial applications. In solar cells, particularly in photovoltaic (PV) modules, POE is primarily used as a packaging material. Packaging materials are critical components of solar panels and provide the following key functions:

Protection: packaging materials protect delicate solar cells from mechanical stress, moisture, and other environmental hazards with a view to preventing performance degradation over time.

2. Electrical insulation: packaging materials provide electrical isolation between electrical layers to prevent short circuits and to ensure proper electrical performance.

3. Optical transparency: packaging materials must allow maximum light transmission to the solar cells in order to ensure high efficiency.

Traditionally, ethylene-vinyl acetate (EVA) has been the most commonly used packaging material for solar cells. However, POE has become increasingly popular due to several advantages over EVA, including the following:

Improved durability: POE exhibits superior resistance to potential-induced degradation (PID). PID is a phenomenon in which the performance of solar cells deteriorates over time under conditions of high voltage stress and moisture ingress.

2. Thermal stability: POE has a higher melting point than EVA, so POE is more stable at high temperatures. Thermal stability is particularly important for solar installations in hot climates.

3. Lower water absorption: POE has a lower water absorption rate, which can provide better protection against humidity and moisture and prevent long-term degradation of solar cells.

4. Improved optical properties: POE can provide better transparency and does not yellow over time, which can maintain the efficiency of the solar cells.

Due to enhanced durability, thermal stability, and improved protective properties of POE, POE packaging materials have become increasingly popular in the solar industry. Compared with currently available materials such as EVA, these advantages contribute to improved service life and efficiency of solar panels. Accordingly, POE has become an attractive option for modern solar photovoltaic systems.

However, currently available POE packaging films typically employ a low-temperature process during packaging, which often results in significant film shrinkage due to stress effects. In addition, the material properties of currently available POE packaging films still require further improvement. In view of the foregoing, it has become an important issue to provide an improved packaging film manufacturing process so as to overcome the problems existing in the prior art.

### SUMMARY

One embodiment of the disclosure provides a manufacturing method of packaging film. The method is performed by a film manufacturing system, and the film manufacturing system includes an extruder, a hanger-shaped die head, and a leveling machine. The extruder includes a feed inlet, a main body, a threaded rod, a heater, and a discharge outlet. The feed inlet and the discharge outlet are respectively disposed at the two ends of the main body. The threaded rod is disposed in the main body, and the heater is connected to the main body. The hanger-shaped die head extends in a gradually widening manner and is connected to the discharge outlet of the extruder. The leveling machine is disposed at one side of the hanger-shaped die head. The method includes the following steps: performing a pelletizing process for a polyolefin elastomer, a crosslinking agent, and a silane coupling agent while simultaneously performing a crosslinking and grafting reaction to produce a plurality of material pellets, where the material pellets include a first portion in which the crosslinking and grafting reaction has been completed and a second portion in which the crosslinking and grafting reaction has not been completed; mixing the first portion and the second portion to produce a mixed material; feeding the mixed material into the feed inlet of the extruder, and heating and compressing the mixed material by the heater and the screw of the extruder; delivering the heated and compressed mixed material from the discharge outlet of the extruder to the hanger-shaped die head; extruding the mixed material through the hanger-shaped die head to form the packaging film; and leveling the packaging film by the leveling machine.

In one embodiment, the first portion accounts for 60% to 80% of the material pellets, and the second portion accounts for 20% to 40% of the material pellets.

In one embodiment, the first portion accounts for 65% to 75% of the material pellets, and the second portion accounts for 25% to 35% of the material pellets.

In one embodiment, the weight ratio of the polyolefin elastomer, the crosslinking agent, and the silane coupling agent is 100: a first value: a second value. The first value is 0.1 to 0.6, and the second value is 0.7 to 1.5.

In one embodiment, the first value is 0.3 to 0.5, and the second value is 0.9 to 1.3.

In one embodiment, the heating temperature of the heater is 150° C. to 160° C.

In one embodiment, the thickness of the packaging film after leveling is 40 μm to 600 μm.

In one embodiment, the crosslinking agent is dicumyl peroxide.

In one embodiment, the silane coupling agent is 3-(trimethoxysilyl) propylmethacrylate.

Another embodiment of the disclosure provides a packaging film, and the packaging film is manufactured by the above method.

The packaging film and the manufacturing method thereof in accordance with the embodiments of the disclosure may have the following advantages:
(1) In one embodiment of the disclosure, the packaging film has a specific material composition and is manufactured by a specific manufacturing method. Accordingly, the produced packaging film can achieve high transparency, low water absorption, and easy delamination. In addition, no acid is generated during the manufacturing process. At the same time, the weather resistance of the packaging film can be significantly improved. Therefore, the packaging film is well suited for use in various packaging processes (such as photovoltaic modules) so as to satisfy the requirements of different applications.
(2) In one embodiment of the disclosure, during pelletizing of the packaging film manufacturing method, the crosslinking and grafting reaction is performed simultaneously. The resulting material pellets include a first portion in which the crosslinking and grafting reaction has been completed and a second portion in which the crosslinking and grafting reaction has not been completed. The first portion and the second portion are then mixed to produce a mixed material, such that the mixed material contains a predetermined proportion of reacted material. As a result, a higher processing temperature can be used in a subsequent film-forming process to reduce the shrinkage rate, which can substantially improve the problem of film shrinkage caused by insufficient processing temperature in currently available packaging film manufacturing processes.
(3) In one embodiment of the disclosure, the material properties of the packaging film enable the packaging film to be applied in low-temperature packaging processes (110° C. or lower), and the packaging film is recyclable for repeated use. Accordingly, the packaging film can be more comprehensive in application and more flexible in use.
(4) In one embodiment of the present disclosure, the packaging film exhibits excellent material properties and thus can be applied in various fields. In addition to packaging of photovoltaic modules, the packaging film can also be applied to packaging materials, construction materials, the automotive industry, electronic and electrical products, and medical products.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a cross-sectional view of a packaging assembly according to one embodiment of the disclosure.

FIG. 2 is a first schematic view of a film manufacturing system according to one embodiment of the disclosure.

FIG. 3 is a second schematic view of the film manufacturing system according to one embodiment of the disclosure.

FIG. 4 is a flowchart of a manufacturing method of packaging film according to one embodiment of the disclosure.

### DETAILED DESCRIPTION

In order to provide a more detailed and complete description of the present disclosure, the following text sets forth illustrative descriptions of embodiments and specific examples of the present disclosure; however, the embodiments and specific examples of the present disclosure are not limited thereto.

Unless otherwise specified, the scientific and technical terms used in this specification have the meanings commonly understood and ordinarily used by a person having ordinary skill in the art. Furthermore, the terms used in this specification encompass both singular and plural forms, unless otherwise indicated.

As used herein, the term “about” generally refers to an actual value within ±10%, ±5%, ±1%, or ±0.5% of a specified value or range. The term “about” as used herein represents that an actual value falls within an acceptable standard error of the mean, as would be understood by a person having ordinary skill in the art. Except for experimental examples or unless otherwise expressly stated, it should be understood that the ranges, amounts, values, and percentages used herein are modified by the term “about.” Accordingly, unless otherwise specified, the numerical values or parameters disclosed in this specification and the accompanying patent claims are approximate and may vary as required.

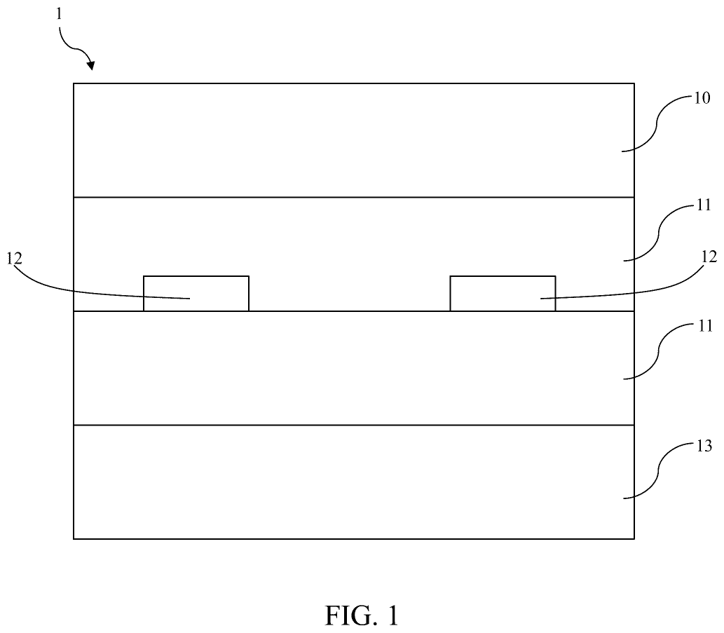

Please refer to FIG. 1, which is a cross-sectional view of a packaged assembly according to one embodiment of the disclosure. As shown in FIG. 1, the packaged assembly 1 may include a glass substrate 10, two packaging films 11, two packaging components 12, and a back sheet 13. In this embodiment, the packaged assembly 1 may be a solar cell, and the packaging components 12 may be solar cell units.

The packaging film 11 is disposed on the back sheet 13, and the packaging components 12 are disposed on the packaging film 11. Another packaging film 11 is disposed on the packaging components 12. Accordingly, the two packaging films 11 can enclose the packaging components 12 for packaging in order to form a protective structure. The glass substrate 10 is disposed on the packaging film 11 located above the packaging components 12.

The packaging film is made of a mixed material. The mixed material includes a polyolefin elastomer (POE), a crosslinking agent, and a silane coupling agent. The weight ratio of the polyolefin elastomer, the crosslinking agent, and the silane coupling agent is 100:a first value:a second value. The first value may be 0.1 to 0.6, and the second value may be 0.7 to 1.5. In another embodiment, the first value may be 0.3 to 0.5, and the second value may be 0.9 to 1.3. The thickness of the packaging film is 40 μm to 600 μm. For example, the weight ratio of the polyolefin elastomer, the crosslinking agent, and the silane coupling agent may be 100:0.6:1.4. The material properties of the packaging film 11 enable the packaging film 11 to be applied in low-temperature packaging processes (110° C. or lower; for instance, the packaging temperature may range from 10° C. to 110° C.).

The polyolefin elastomer (POE) is an elastomer copolymerized from ethylene and 1-octene or other α-olefins. As described above, raw materials for manufacturing the POE packaging film of this embodiment mainly include: (1) POE polymer: including ethylene as a primary base monomer to provide a basic structure and elasticity of POE, and comonomers such as α-olefins including 1-octene, 1-butene, and 1-hexene, which are copolymerized with ethylene to adjust material structure and properties, such as improving flexibility and transparency; (2) Crosslinking agent: used to promote crosslinking of POE to enhance material strength and durability (crosslinking reaction). In this embodiment, the crosslinking agent is dicumyl peroxide (DCP); and (3) Silane coupling agent: used to enhance adhesion between POE and other materials such as glass and solar cells (grafting reaction). The silane coupling agent used in this embodiment contains at least one silane group and may, but is not limited to, 3-(trimethoxysilyl) propylmethacrylate. In yet another embodiment, reactive additives, including triallyl phosphate and the like, may be further added.

In addition to the above-described packaging applications for photovoltaic components, particularly solar cells, the POE film (packaging material film) of the disclosure may also be applied, but is not limited to, the following fields:

Packaging materials: commonly used for manufacturing plastic wrap, food packaging films, and the like, due to good gas permeability and tear resistance.

2. Building materials: applicable to waterproof membranes, vapor barrier films, and other construction materials to improve durability and waterproof performance of buildings.

3. Automotive industry: widely used in automotive interior and exterior decoration components, such as door and window sealing strips and seat materials, to enhance comfort and durability of vehicles.

4. Electronics and electrical applications: usable as insulation materials for cables and cable terminals to improve heat resistance and electrical performance.

5. Medical products: applicable in the medical field, such as for manufacturing medical dressings and medical packaging materials, due to good biocompatibility and antibacterial properties.

The embodiment just exemplifies the present disclosure and is not intended to limit the scope of the present disclosure; any equivalent modification and variation according to the spirit of the present disclosure is to be also included within the scope of the following claims and their equivalents.

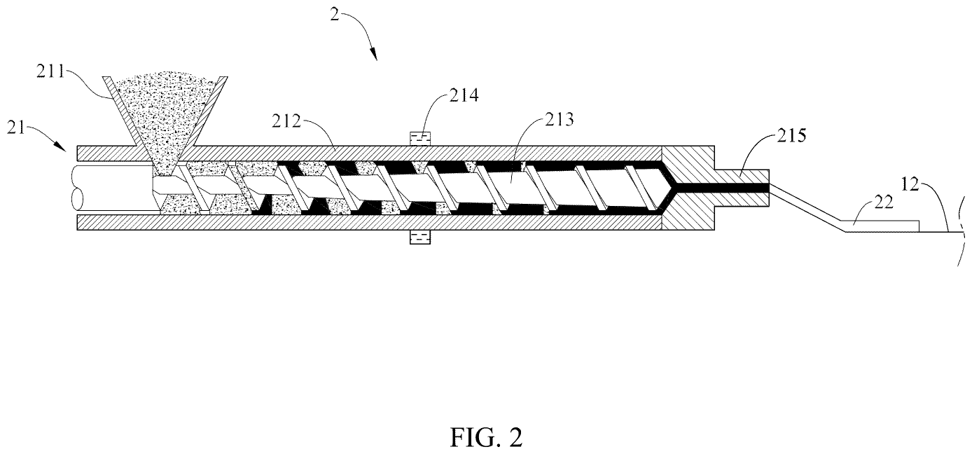

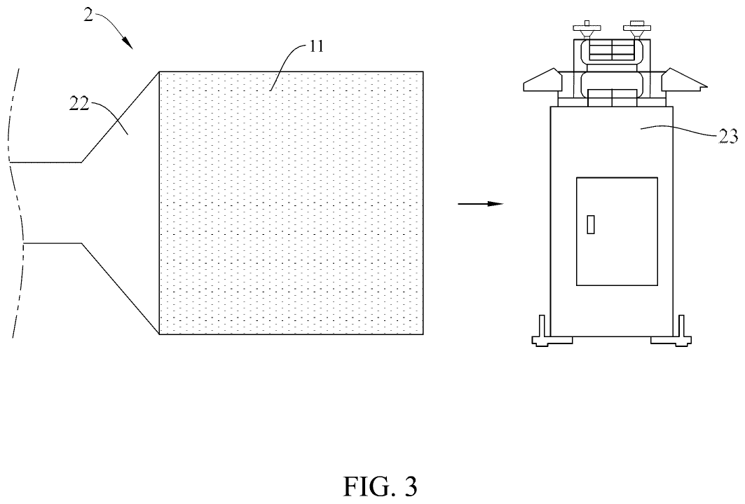

Please refer to FIG. 2 and FIG. 3. FIG. 2 is a first schematic view of a film manufacturing system according to one embodiment of the disclosure. FIG. 3 is a second schematic view of the film manufacturing system according to one embodiment of the disclosure. As shown in FIG. 2 and FIG. 3, the film manufacturing system 2 includes an extruder 21, a hanger-shaped die head 22, and a leveling machine 23.

The extruder 21 includes a feed inlet 211, a main body 212, a threaded rod 213, a heater 214, and a discharge outlet 215. The feed inlet 211 and the discharge outlet 215 are respectively disposed at the two ends of the main body 212. The threaded rod 213 is disposed inside the main body 212. The heater 214 is connected to the main body 212. The hanger-shaped die head 22 extends in a gradually widening manner, with a narrower end connected to the discharge outlet 215 of the extruder 21 and a wider end facing the leveling machine 23. The leveling machine 23 is disposed at one side of the hanger-shaped die head 22.

First, the polyolefin elastomer, the crosslinking agent, and the silane coupling agent are pelletized by extrusion or other pelletizing processes, while the crosslinking and grafting reaction is simultaneously performed under appropriate temperature and pressure conditions to produce a plurality of material pellets. The material pellets include a first portion in which the crosslinking and grafting reaction has been completed and a second portion in which the crosslinking and grafting reaction has not been completed. Such material characteristics allow a higher processing temperature to be used in a subsequent film-forming process, which can substantially improve film shrinkage caused by stress due to excessively low processing temperatures. As described above, the weight ratio of the polyolefin elastomer, the crosslinking agent, and the silane coupling agent is 100:the first value:the second value. The first value may be 0.1 to 0.6, and the second value may be 0.7 to 1.5. In another embodiment, the first value may be 0.3 to 0.5, and the second value may be 0.9 to 1.3. For example, the weight ratio may be 100:0.4:1.1, or 100:0.5:1.2. The first portion accounts for 60% to 80% of the material pellets, and the second portion accounts for 20% to 40% of the material pellets. In another embodiment, the first portion accounts for 65% to 75% of the material pellets, and the second portion accounts for 25% to 35% of the material pellets. For example, the first portion may account for 80% and the second portion may account for 20%, or the first portion may account for 70% and the second portion may account for 30%.

Next, the first portion and the second portion are mixed to produce a mixed material. The mixed material is then fed into the feed inlet 211 of the extruder 21, and the threaded rod 213 of the extruder 21 rotates to compress the mixed material. Meanwhile, the heater 214 of the extruder 21 heats the mixed material during compression. The heating temperature of the heater 214 is 150° C. to 160° C. A curing process is performed under appropriate temperature and pressure conditions, so that the mixed material is completely cured and forms a stable structure.

Thereafter, after compression and heating are completed, the mixed material is delivered through the discharge outlet 215 of the extruder 21 to the hanger-shaped die head 22, and the mixed material is extruded through the hanger-shaped die head 22 to form the packaging film 11.

Finally, the packaging film 11 is conveyed to the leveling machine 23 and leveled by the leveling machine 23.

In another embodiment, after the hanger-shaped die head 22 extrudes the mixed material to form the packaging film 11, a thickness detection device detects a film thickness of the packaging film 11 and provides real-time feedback to the film manufacturing system 2. Accordingly, the gap of the hanger-shaped die head 22 can be adjusted in real time to further achieve uniform film thickness and reduce tolerances. The thickness detection device may be a currently available probe device or an infrared detection device. The thickness detection may be performed by single-point detection, multi-point detection, or repetitive scanning along the direction parallel to the outlet direction of the hanger-shaped die head 22. The above examples are for illustrative purposes only and are not intended to limit the scope of the disclosure.

Through the above-described film manufacturing system 2, which integrates the extruder 21, the hanger-shaped die head 22, and the leveling machine 23, and through the specific manufacturing process, the packaging film 11 is produced with a uniform thickness (approximately between 40 μm and 600 μm), and improved surface flatness, while manufacturing tolerances of the packaging film 11 can be substantially reduced.

The embodiment just exemplifies the present disclosure and is not intended to limit the scope of the present disclosure; any equivalent modification and variation according to the spirit of the present disclosure is to be also included within the scope of the following claims and their equivalents.

It is worthy to point out that currently available POE packaging films typically employ a low-temperature process during packaging, which often results in significant film shrinkage due to stress effects. In addition, the material properties of currently available POE packaging films still require further improvement. By contrast, according to one embodiment of the disclosure, the packaging film has a specific material composition and is manufactured by a specific manufacturing method. Accordingly, the produced packaging film can achieve high transparency, low water absorption, and easy delamination. In addition, no acid is generated during the manufacturing process. At the same time, the weather resistance of the packaging film can be significantly improved. Therefore, the packaging film is well suited for use in various packaging processes (such as photovoltaic modules) so as to satisfy the requirements of different applications.

In addition, according to one embodiment of the disclosure, during pelletizing of the packaging film manufacturing method, the crosslinking and grafting reaction is performed simultaneously. The resulting material pellets include a first portion in which the crosslinking and grafting reaction has been completed and a second portion in which the crosslinking and grafting reaction has not been completed. The first portion and the second portion are then mixed to produce a mixed material, such that the mixed material contains a predetermined proportion of reacted material. As a result, a higher processing temperature can be used in a subsequent film-forming process to reduce the shrinkage rate, which can substantially improve the problem of film shrinkage caused by insufficient processing temperature in currently available packaging film manufacturing processes.

Further, according to one embodiment of the disclosure, the material properties of the packaging film enable the packaging film to be applied in low-temperature packaging processes (110° C. or lower), and the packaging film is recyclable for repeated use. Accordingly, the packaging film can be more comprehensive in application and more flexible in use.

Moreover, according to one embodiment of the disclosure, the packaging film exhibits excellent material properties and thus can be applied in various fields. In addition to packaging of photovoltaic modules, the packaging film can also be applied to packaging materials, construction materials, the automotive industry, electronic and electrical products, and medical products. As previously stated, the packaging film according to the embodiments of the disclosure can indeed achieve great technical effects.

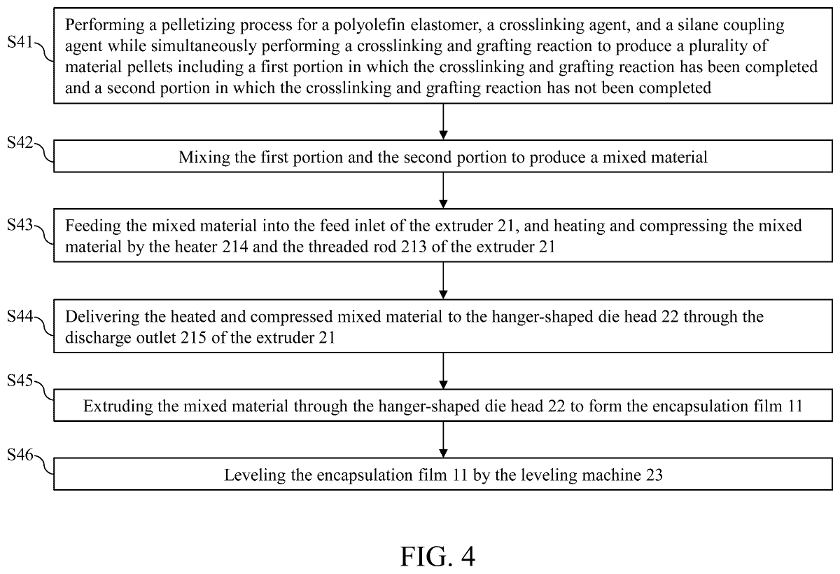

Please refer to FIG. 4, which is a flowchart of a manufacturing method of packaging film according to one embodiment of the disclosure. The packaging film 11 can be manufactured by a film manufacturing system 2. The film manufacturing system 2 includes an extruder 21, a hanger-shaped die head 22, and a leveling machine 23.

The extruder 21 includes a feed inlet 211, a main body 212, a threaded rod 213, a heater 214, and a discharge outlet 215. The feed inlet 211 and the discharge outlet 215 are respectively disposed at the two ends of the main body 212. The threaded rod 213 is disposed in the main body 212. The heater 214 is connected to the main body 212. The hanger-shaped die head 22 extends in a gradually widening manner. The narrower end of the hanger-shaped die head 22 is connected to the discharge outlet 215 of the extruder 21, and the wider end thereof faces the leveling machine 23. The leveling machine 23 is disposed on one side of the hanger-shaped die head 22. As shown in FIG. 4, the manufacturing method according to this embodiment includes the following steps.

Step S41: performing a pelletizing process for a polyolefin elastomer, a crosslinking agent, and a silane coupling agent while simultaneously performing a crosslinking and grafting reaction to produce a plurality of material pellets including a first portion in which the crosslinking and grafting reaction has been completed and a second portion in which the crosslinking and grafting reaction has not been completed.

Step S42: mixing the first portion and the second portion to produce a mixed material.

Step S43: feeding the mixed material into the feed inlet of the extruder 21, and heating and compressing the mixed material by the heater 214 and the threaded rod 213 of the extruder 21. The heater 214 of the extruder 21 heats the mixed material during compression and the heating temperature of the heater 214 is 150° C. to 160° C.

Step S44: delivering the heated and compressed mixed material to the hanger-shaped die head 22 through the discharge outlet 215 of the extruder 21.

Step S45: extruding the mixed material through the hanger-shaped die head 22 to form the packaging film 11.

Step S46: leveling the packaging film 11 by the leveling machine 23.

The embodiment just exemplifies the present disclosure and is not intended to limit the scope of the present disclosure; any equivalent modification and variation according to the spirit of the present disclosure is to be also included within the scope of the following claims and their equivalents.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

To sum up, according to one embodiment of the disclosure, the packaging film has a specific material composition and is manufactured by a specific manufacturing method. Accordingly, the produced packaging film can achieve high transparency, low water absorption, and easy delamination. In addition, no acid is generated during the manufacturing process. At the same time, the weather resistance of the packaging film can be significantly improved. Therefore, the packaging film is well suited for use in various packaging processes (such as photovoltaic modules) so as to satisfy the requirements of different applications.

In addition, according to one embodiment of the disclosure, during pelletizing of the packaging film manufacturing method, the crosslinking and grafting reaction is performed simultaneously. The resulting material pellets include a first portion in which the crosslinking and grafting reaction has been completed and a second portion in which the crosslinking and grafting reaction has not been completed. The first portion and the second portion are then mixed to produce a mixed material, such that the mixed material contains a predetermined proportion of reacted material. As a result, a higher processing temperature can be used in a subsequent film-forming process to reduce the shrinkage rate, which can substantially improve the problem of film shrinkage caused by insufficient processing temperature in currently available packaging film manufacturing processes.

Further, according to one embodiment of the disclosure, the material properties of the packaging film enable the packaging film to be applied in low-temperature packaging processes (110° C. or lower), and the packaging film is recyclable for repeated use. Accordingly, the packaging film can be more comprehensive in application and more flexible in use.

Moreover, according to one embodiment of the disclosure, the packaging film exhibits excellent material properties and thus can be applied in various fields. In addition to packaging of photovoltaic modules, the packaging film can also be applied to packaging materials, construction materials, the automotive industry, electronic and electrical products, and medical products.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A manufacturing method of packaging film, performed by a film manufacturing system comprising an extruder, a hanger-shaped die head, and a leveling machine, wherein the extruder comprises a feed inlet, a main body, a threaded rod, a heater, and a discharge outlet, the feed inlet and the discharge outlet are respectively disposed at two ends of the main body, the threaded rod is disposed in the main body, and the heater is connected to the main body; wherein the hanger-shaped die head extends in a gradually widening manner and is connected to the discharge outlet of the extruder; and the leveling machine is disposed at one side of the hanger-shaped die head, the method comprises:
performing a pelletizing process for a polyolefin elastomer, a crosslinking agent, and a silane coupling agent while simultaneously performing a crosslinking and grafting reaction to produce a plurality of material pellets comprising a first portion in which the crosslinking and grafting reaction has been completed and a second portion in which the crosslinking and grafting reaction has not been completed;
mixing the first portion and the second portion to produce a mixed material;
feeding the mixed material into the feed inlet of the extruder, and heating and compressing the mixed material by the heater and the screw of the extruder;
delivering the mixed material having been heated and compressed from the discharge outlet of the extruder to the hanger-shaped die head;
extruding the mixed material through the hanger-shaped die head to form a packaging film; and
leveling the packaging film by the leveling machine.

2. The manufacturing method of packaging film as claimed in claim 1, wherein the first portion accounts for 60% to 80% of the material pellets, and the second portion accounts for 20% to 40% of the material pellets.

3. The manufacturing method of packaging film as claimed in claim 1, wherein the first portion accounts for 65% to 75% of the material pellets, and the second portion accounts for 25% to 35% of the material pellets.

4. The manufacturing method of packaging film as claimed in claim 1, wherein a weight ratio of the polyolefin elastomer, the crosslinking agent, and the silane coupling agent is 100:a first value:a second value, and the first value is 0.1 to 0.6, and the second value is 0.7 to 1.5.

5. The manufacturing method of packaging film as claimed in claim 4, wherein the first value is 0.3 to 0.5, and the second value is 0.9 to 1.3.

6. The manufacturing method of packaging film as claimed in claim 1, wherein a heating temperature of the heater is 150° C. to 160° C.

7. The manufacturing method of packaging film as claimed in claim 1, wherein a thickness of the packaging film after leveling is 40 μm to 600 μm.

8. The manufacturing method of packaging film as claimed in claim 1, wherein the crosslinking agent is dicumyl peroxide.

9. The manufacturing method of packaging film as claimed in claim 1, wherein the silane coupling agent is 3-(trimethoxysilyl) propylmethacrylate.

10. A packaging film, manufactured by the method of claim 1.
